(19) United States
(12) Patent Application Publication
(10) Pub. No.: US 2016/0189111 A1
(43) Pub. Date: Jun. 30, 2016

(54) FREE TIME ACTIVITY SCHEDULER

(71) Applicant: SKEDGO PTY LTD, New South Wales (AU)

(72) Inventors: Phil Bookallil, The Rocks (AU); Claus Von Hessberg, The Rocks (AU)

(73) Assignee: SKEDGO PTY LTD, The Rocks (AU)

(21) Appl. No.: 14/908,733

(22) PCT Filed: Jul. 29, 2014
(86) PCT No.: PCT/AU2014/050153

§ 371 Date: Jan. 29, 2016

(30) Foreign Application Priority Data
Jul. 29, 2013 (AU) 2013902807

(51) Int. Cl. G06Q 10/10

(52) U.S. Cl. CPC G06Q 10/1095

(57) ABSTRACT

This disclosure relates to managing a time period in a calendar application between multiple events. A processor receives from a requesting device a request for time management data. The processor then determines for each of multiple activities having respective activity locations an available length of time for performing that activity within the time period. This determination is based on a travel time for travelling between the event locations and the activity location of that activity. The processor sends the time management data including the available length of time for each of the multiple activities to the requesting device. The requesting device has the available length of time for each activity available and can provide this information to a user of the device. The user can think about whether the available length of time is sufficient for the respective activity and therefore supports a better and more efficient planning outcome.

### CROSS-REFERENCE TO RELATED APPLICATIONS

The present application claims priority from Australian Provisional Patent Application No 2013902807 filed on 29 Jul. 2013, the content of which is incorporated herein by reference.

### TECHNICAL FIELD

This disclosure relates to managing a time period in a calendar application between multiple events. In particular, but not limited to, this disclosure relates to methods, software and a computer systems for managing a time period between multiple events.

### BACKGROUND ART

Many professionals use sophisticated calendar applications, such as Microsoft Outlook, Google Calendar, iOS Calendar and the like, to manage events, such as meetings. In many cases, there is a gap or free time between events and the users want to use that free time for performing an activity. However, it is often difficult for the user to decide which activity to pursue.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### DISCLOSURE OF INVENTION

A computer implemented method for managing a time period in a calendar application between multiple events associated with respective event locations comprises:

receiving from a requesting device a request for time management data;

determining for each of the multiple activities having respective activity locations an available length of time for performing that activity within the time period based on a travel time for travelling between the event locations and the activity location of that activity; and

sending the time management data including the available length of time for each of the multiple activities to the requesting device.

It is an advantage that an available length of time is determined for multiple activities and sent to the requesting device. As a result, the requesting device has the available length of time for each activity available and can provide this information to a user of the device. The user can think about whether the available length of time is sufficient for the respective activity and therefore supports a better and more efficient planning outcome.

The method may further comprise determining for each activity a routing for travelling between the event locations and the activity location of that activity wherein determining the travel time is based on the routing.

It is an advantage that the travel time is based on a routing because the routing allows a more accurate estimation of the travel time and therefore allows for more accurate planning.

The routing may be based one or more transport modes that are available for travelling between the event locations and the activity location during the time period.

It is an advantage that the method considers transport modes that are available during the time period. As a result, the travel time is more accurate since the muting is time dependent, such as by considering public transport options with known schedules. For example, a bus connection may not be operating between the event locations and the activity location during the time period and therefore, a route using this bus connection would be inaccurate.

The method may further comprise determining a distance to each of the activity locations and sending the distance to the requesting device.

Determining the distance may be based on one or more of:

a distance from one of the multiple events to the activity location;

a distance from a route between the multiple events to the activity location;

a distance difference between travelling between the multiple event locations directly and travelling between the multiple event locations via the activity location.

One of the multiple activities may be a meeting with a contact and determining the available length of time for the one activity may be based on an availability of the contact at the activity location of the one activity.

It is an advantage that the availability of a contact is integrated into the method. As a result, the user of the method does not need to check with the contact but can see directly how much time is available with the contact, which may be less than the available length of time that is based on only the travel time.

One of the multiple activities may be a meeting of a user of the calendar application with a contact and the method further comprises determining the activity location of the one activity such that a cost for the user and the contact is minimised.

It is an advantage that the cost for both the user and the contact is minimised. As a result, it is more likely that both agree to meet at the activity location, which results in a better planning outcome.

Software, when installed on a computer, causes the computer to perform the above method.

A computer system for managing a time period in a calendar application between multiple events associated with respective event locations comprises:

a data store to store for each of multiple activities an activity location and to store for each of the multiple events the associated event location;

a processor to determine for each of the multiple activities an available length of time for performing that activity within the time period based on a travel time for travelling between the event locations and the activity location of that activity; and

a data port to send the time management data including the available length of time for each of the multiple activities to the requesting device.

A computer implemented method for managing a time period in a calendar application between multiple events associated with respective event locations comprises:

receiving for each of the multiple activities associated with respective activity locations an available length of time for performing that activity within the time period based on a travel time for travelling between the event locations and the activity location of that activity; and

generating a display for use in the calendar application, the display comprising for each of the one or more activities an indication of the available length of time for performing that activity and displaying an option for the user to select one of the multiple activities.

It is an advantage that an available length of time is received and included in the display for multiple activities. As a result, a user of the calendar application can see the available length of time for each activity and decide which activity the user wants to select. The user can think about whether the available length of time is sufficient for the respective activity and therefore supports a better and more efficient planning outcome.

The display may further comprise a selectable marker for each of the one or more activities as the option for the user to select one of the multiple activities.

It is an advantage that a user can select one of the markers on the display, which makes it easy for the user to select one activity.

The placement of the marker along an axis of the display may be indicative of the available length of time.

It is an advantage that the activities are arranged along an axis according to their available length of time which means that the activities are sorted by available length of time. As a result, the user can easily see which activities have the longest or shortest available length of time. Even if the user is not interested in the activity with the longest length of time, the user can see which activity has the second or third longest length of time and the user may be more interested in those activities.

The placement of the marker along an axis of the display may be indicative of the travel time to the activity location.

The placement of the marker along an axis of the display may be indicative of a distance to the activity location.

The display may comprise a map with a selectable marker for each of the multiple activities and the placement of the marker on the map is indicative of the activity location.

It is an advantage that the map provides the user with an additional selection criterion and therefore makes it easier for the user to make the best decision.

The map may comprise an indication of a boundary that indicates locations that when taken as activity location result in an available length of time above a time threshold.

It is an advantage that the user can see from the map which locations the user can reach while still being able to spend at least a set time at that location. This allows more flexibility in planning and gives the user a feel for the locations that are possible to reach.

A visual appearance of each marker may be indicative of an activity type.

It is an advantage that the user can visually distinguish between different types and decide to only consider or prioritise the activities of a certain type.

Software, when installed on a computer causes the computer to perform the latter method for managing a time period in a calendar application.

A computer system for managing a time period in a calendar application between multiple events associated with respective event locations comprises:

a data port to receive for each of the multiple activities associated with respective activity locations an available length of time for performing that activity within the time period based on a travel time for travelling between the event locations and the activity location of that activity; and

a processor to generate a display for use in the calendar application, the display comprising for each of the one or more activities an indication of the available length of time for performing that activity and displaying an option for the user to select one of the multiple activities.

The computer system may further comprise a display device to show the display generated by the processor to a user.

Optional features described of any aspect of method, software or computer system, where appropriate, similarly apply to the other aspects also described here.

### BRIEF DESCRIPTION OF DRAWINGS

An example will be described with reference to

FIG. 1 illustrates a computer system for managing a time period in a calendar application.

FIG. 2 illustrates a method for managing a time period in a calendar application.

FIG. 3 illustrates a display used in a calendar application.

FIG. 4 illustrates a detailed view of a transport route.

FIG. 5 illustrates the display after a friend flag has been selected.

FIG. 6 illustrates the display allowing user data entry.

FIG. 7 illustrates a computer network.

FIG. 8a illustrates a method for managing a time period as performed by a virtual machine.

FIG. 8b illustrates a method for managing a time period as performed by smart phone.

### BEST MODE FOR CARRYING OUT THE INVENTION

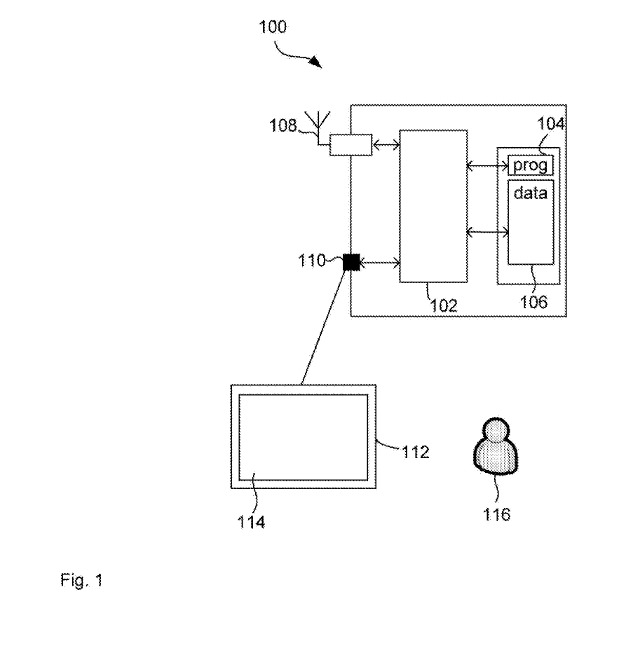

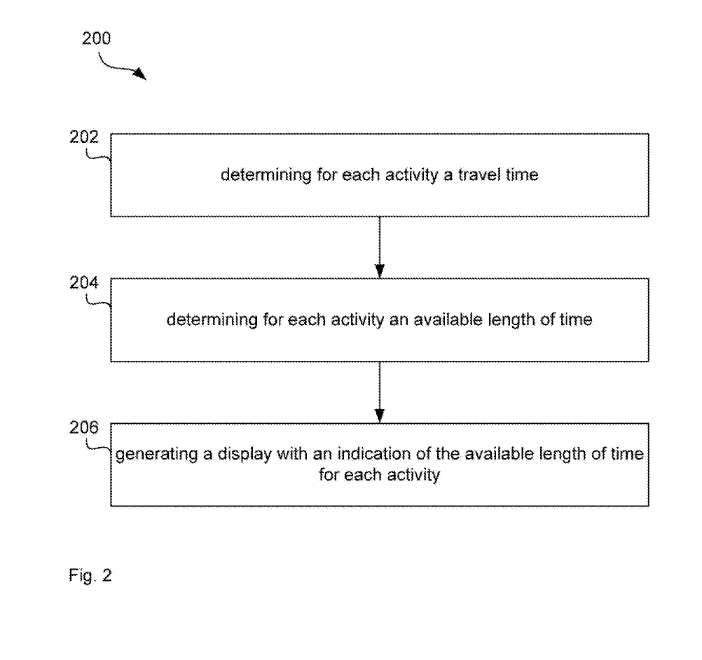

FIG. 1 illustrates a computer system 100 for managing a time period in a calendar application. The computer system comprises a processor 102 connected to a program memory 104, a data memory 106, a communication port 108 and a user port 110. The program memory 104 is a non-transitory computer readable medium, such as a hard drive, a solid state disk or CD-ROM. Software, that is an executable program, stored on program memory 104 causes the processor 102 to perform the method in FIG. 2, that is, the processor 102 determines travel times for multiple activities and an available length of time for performing each activity. The processor 102 then generates a display indicating the available length of time for each activity.

The processor 102 may receive data, such as calendar entries for events and activity information, from data memory 106 as well as from the communications port 108 and the user port 110, which is connected to a screen 112 that shows the display 114 generated by processor 102 to a user 116. In one example, the processor 102 receives event or activity data from a calendar server, such as Google Calendar, via communications port 108, such as by using a Wi-Fi network according to IEEE 802.11. When the user 116 makes changes to calendar items, such as by adding an additional event, the processor 102 synchronises the calendar items with the server, such that the data on the server and the data on the data memory 106 are the same.

The Wi-Fi network may be a decentralised ad-hoc network, such that no dedicated management infrastructure, such as a router, is required or a centralised network with a router or access point managing the network. Of course, the processor 102 may also receive the data by the user 116 entering the data.

Although communications port 108 and user port 110 are shown as distinct ports, it is to be understood that any kind of data port may be used to receive data, such as a network connection, a memory interface, a pin of the chip package of processor 102, or logical ports, such as IP sockets or parameters of functions stored on program memory 104 and executed by processor 106. These parameters may be stored on data memory 106 and may be handled by-value or by-reference, that is, as a pointer, in the source code.

The processor 102 may receive data through all these interfaces, which includes memory access of volatile memory, such as cache or RAM, or non-volatile memory, such as an optical disk drive, hard disk drive, storage server or cloud storage. The computer system 100 may further be implemented within a cloud computing environment, such as a managed group of interconnected servers hosting a dynamic number of virtual machines.

It is to be understood that ‘determining something’ can mean performing the actual computation to determine something but can also mean sending a request to a remote computer system, such that the remote computer system performs the actual computation or provides pre-computed values.

For example, the computer system 100 may be a smart phone or tablet computer providing a user interface, such as a smart phone app, to communicate with a web service. The web service is a calendar service that stores multiple events in a calendar for the user 116. The web service provides access to a routing engine and the smart phone 100 can send a request to the web service to determine a route between two events stored on the web service. The smart phone 100 receives the muting from the web service and this process is also referred as determining the routing.

It is to be noted here that a calendar application is not limited to software that is installed on the smart phone or tablet computer. Instead, a server may also perform the steps described herein and generate the display in form of graphical commands, such as a png, svg or html/css file and sends the display to the mobile device.

It is to be understood that any receiving step may be preceded by the processor 102 determining or computing the data that is later received. For example, the processor 102 determines an activity location and stores the activity location in data memory 106, such as RAM or a processor register. The processor 102 then requests the data from the data memory 106, such as by providing a read signal together with a memory address. The data memory 106 provides the data as a voltage signal on a physical bit line and the processor 102 receives the activity location via a memory interface.

FIG. 2 illustrates a method 200 as performed by processor 102 for managing a time period in a calendar application, such as Google Calendar, Microsoft Outlook or any other proprietary calendar software. The time period is also referred to as free time since it is the time period between multiple events where the user has not planned anything. However, the user 116 would like to use that time most effectively and perform one or more activities. However, it is difficult for the user 116 to decide which activity to choose because each activity is at a different location and it is difficult for the user to determine how much time is actually available for performing the activity at that location.

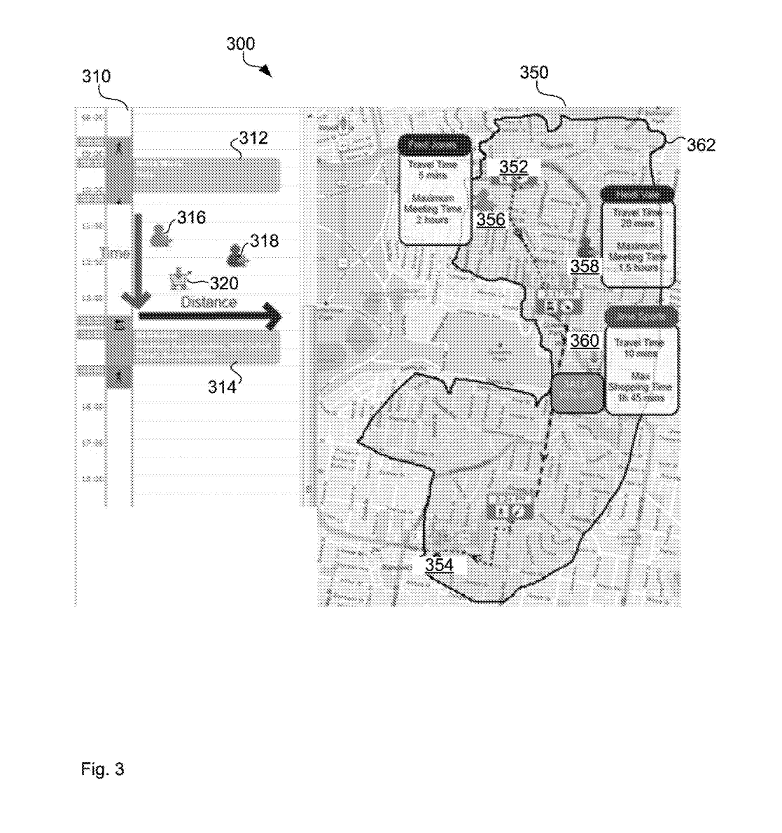

FIG. 3 illustrates a display 300 used in a calendar application also referred to as graphical user interface (GUI) 300. The GUI 300 comprises a calendar view panel 310 and a map view panel 350. In the calendar view panel 310 there is a first event item 312 and a second event item 314, which are associated with a first event location 352 and a second event location 352, respectively, as shown in the map panel 350. The first event item 312 and second event item 314 may be of various different types, such as meetings, scheduled tasks, telephone calls and all other types of events that users may keep track of in a calendar application.

In examples where the computer system 100 is a smart phone or tablet computer, the processor 102 may execute an installed app, such as an iOS or Android app, to perform the actual computation to create the elements of the display 300. However, the processor 102 may also generate the display 300 by receiving graphical elements or other instructions, such as a png, svg or html/css file, and causing the display of the received elements to the user 116.

In the example of FIG. 3, there are three activities that the user 116 can choose from. The first activity is to meet with Fred Jones. This first activity is associated with a first activity location 356. The second activity, associated with a second activity location 358 is to meet with Heidi Vale and the third activity associated with a third activity location 360 is to go shopping at Jims Sports.

Returning back to FIG. 2, the first step of method 200 is that processor 102 determines 202 for the first activity a travel time for travelling from the first event location 352 to the first activity location 356 and from the first activity location 356 to the second event location 354. Similarly, the processor determines the travel times for the second 358 and third 360 activity.

In one example, the processor 102 determines a routing for travelling from the first event 352 to the first activity location 356 and from the first activity location 356 to the second event location 354. Similarly, the processor 102 determines a routing for the second activity and the third activity. The processor 102 can then use the routing to determine a more accurate travel time.

For example, the routing may comprise a path for walking or cycling to the activity or driving a car. Alternatively, determining the routing may comprise retrieving a schedule of a public transport network and determining an itinerary for travelling between the event locations and the activity location. Of course, any combination of these modes of transport is also possible.

It is noted that the method 200 of FIG. 2 may be performed well before the day on which the events and activities take place, such as one month in advance. In that case, the processor 102 has available the end time of the first event 312 and the start time of the second event 314, both of which lying in the future. The processor 102 can then query the public transport schedule or any other time varying transport information, such as traffic estimates or road closures. This way the processor 102 can determine which modes of transport are actually available during the free time, that is, the time period between the first event 312 and the second event 314. The processor 102 then determines the routing based on the transport modes that are available during the free time, such as by excluding transport modes that are not available or only considering available transport modes.

The next step in FIG. 2 is that processor 102 determines 204 an available length of time for performing the first activity 356, such as the maximum time that can be spend in a meeting with Fred Jones. This available length of time is determined based on the travel time. For example, the processor 102 determines the length of the free time period between the first event 312 and second event 314 by subtracting the start time tse2 of the second event 314 from the end time tee1 of the first event:

freetime=tse2−tee1

The processor 102 then determines the available length of time tavaila1 for the first activity by subtracting the travel time tta1 of the first activity from the free time:

tavaila1=freetime−tta1

The same process is repeated for the second and third activity.

In the example of FIG. 3, the first event 312 ends at 10 am and the second event 314 begins at 2 pm, which results in four hours of free time. The travel time from the first activity location 352 to the first activity location 356 is 5 minutes and the travel time from the first activity location 356 to the second event location 354 is 1 hour 55 minutes, which results in an available time of two hours. Similarly, the travel time to the second activity location 358 is 20 minutes and from the second activity location 358 to the second event location 354 is 2 hours 10 minutes, which results in an available time of 1 hour 30 minutes. The travel time to the third activity location 360 is 10 minutes and the travel time from the third activity location 360 to the second event location 354 is 2 hours 5 minutes, which results in an available time of 1 hour 45 minutes for performing the third activity. It is noted here that these travel times may include waiting times for public transport in case, for example, the bus to the second event location 354 only operates hourly or a long walk is necessary to reach a bus stop.

Referring back to FIG. 2, the processor 102 now generates 206 a display, such as display 300, for use in the calendar application. This means that the display 300 is integrated into the calendar application or into the displaying process of the calendar or schedule, such that the user 116 can interact with the calendar application by interacting with the display 300, such as by selecting markers as explained below. The display 300 comprises for each of the one or more activities an indication of the available length of time for performing that activity. In the map view panel 350 of the display in FIG. 3, the available length of time is displayed as a numerical value next to the respective activity location.

The calendar view panel 310 comprises a first marker 316 for the first activity, a second marker 318 for the second activity and a third marker for the third activity. The position of the markers 316, 318 and 320 along a vertical axis represent the available length of time for the respective activity, such that markers that are located closer to the second event item 314 represent a shorter available length of time than markers located closer to the first event item 312. The location along the vertical axis may be proportional to the available length of time, such that if, for example, the free time is from 10 am to 2 pm and the available length of time is three hours, the marker is located at 11 am, that is, three hours before 2 pm.

The markers 316, 318 and 320 are selectable, such that the user 116 can select to perform one of the three activities. For example, the screen 112 may be a touch screen and the user 116 can select the markers by tapping the screen 112 at the location of the markers. When one of the markers is selected, a calendar item is added to the calendar similar to the event items 312 and 314. Additionally, the time for travelling between the event location and the activity location may be marked in the calendar view panel 310 such the user 116 can see that the time needed for travelling is not available to schedule further events or activities.

The user may provide a length of time for performing the selected activity which is less than the available length of time. As a result, there is still a gap, that is, free time, between the selected activity and the next event and the method 200 can be repeated considering the added activity as an event to add a second activity.

In another example, the location of the markers 316, 318 and 320 along the vertical axis is indicative of the travel time to the activity location, such as the additional travel time that is needed on top of the time for travelling directly from the first event location 352 to the second event location 354.

The location of the markers 316, 318 and 320 along the horizontal axis indicates the distance to the activity location. This distance may be defined in a variety of different ways, such as the distance from the first event location 352 to the activity location or the distance from the activity location to the second event location 354. In another example the distance is the distance to the activity location from a route starting at the first event location 352 and ending at the second event location 354, such as from a point on the route that is closest to the activity location to the activity location. In yet another example, the distance is a difference between travelling directly from the first event location 352 to the second event location 354 and travelling from the first event location 352 to the second event location 354 via the activity location.

It is to be noted here that the vertical axis and horizontal axis are just examples and may be swapped or used in any other combination, such as available length of time horizontally and travel time vertically. A third dimension may also be included for a further parameter.

Similar to the markers 316, 318 and 320 in the calendar view panel 310, there are also three markers in the map view panel 350. The markers in the map view panel are located at the location of the activities, such that user 116 can directly see where the activities can be performed. As discussed earlier, these markers on the map are also selectable and the user 116 can add a calendar item by tapping the respective marker on the map 350.

Map 350 further comprises a boundary 362 that indicates the maximum range of movement for the user 116 within the free time period considering the available transport options. This means that all locations within the boundary when taken as an activity location, result in an available length of time that is acceptable by the user. For example, the user may have set in the user's preferences that a minimum time to spend for an activity should be one hour. As a result, the boundary 362 encloses all locations that the user can reach such that the available time at that location is at least one hour. Of course, the minimum time can be set to zero, such that the boundary indicates all locations that the user can reach without coming late to the second event 314.

Instead or in addition to the solid line in FIG. 3, an indication of a boundary may be a shading of an area of all suitable locations or a shading of all location that area outside the boundary or even cropping the map 350 such that the map 350 shows only the relevant locations.

As can be seen in FIG. 3, the markers 316, 318 and 320 have a different appearance, depending on the activity type, that is, whether the associated activity is a meeting or shopping. This way the user can easily see which type of activities are available and can select the type that is most suitable in the current circumstances. The activity types may be a meeting with a friend or business contact, visiting different merchant types, such as food or hardware, following one the user's 116 registered interests, such as visiting an art museum.

In one example, the calendar application stores wildcard scheduled items, such as tasks where time and location is not set but the activity is set. An example for a wildcard scheduled item is to buy flowers for a friend, where it is not important where or when the flowers are bought. The processor 102 accesses these tasks on data store 106 and searches for shops that offer the required service at a given location. The processor 102 then considers this as an activity at that location. It is to be noted that in case of multiple shops for the same service, such as multiple florists near each other, the multiple activities may be the same, that is, buying flowers, but the location for each activity item is different, that is, the different location of each shop. The user can see at which shop the user can spend the most time, or whether it would be worthwhile to spend more time travelling to reach a better shop and still have enough time to buy the flowers.

In one example, the markers 316, 318 and 320 are unique in their appearance in calendar view panel 310. This way the same markers can be used in the map view and it is immediately clear to user 116 which marker in calendar view panel 310 relates to a marker in the map view panel 350 and vice versa.

In one example, the processor 102 can retrieve the calendars of other contacts of user 116, such as Fred Jones, who is the person of the meeting of the first activity. Fred may have events in his calendar during the free time of user 116, which means that the available time for a meeting will be less than the determined time based on the free time and the travel time. The processor 102 identifies Fred's free time during the free time of user 116 and thereby determines an available time to meet with Fred in the free time.

Further, Fred's location at different times during the free time may also be available in Fred's calendar and processor 102 can perform an optimisation algorithm to determine an activity location that minimises the cost for the user 116 and Fred such that the most convenient location for both users is determined. For example, the combined travel time for both Fred and user 116 may be minimised.

It is noted here that although in the example of FIG. 3, the first event location and second event location are different, it is to be understood that they may also be the same in some examples. For example, the user 116 may have two appointments at the same location with free time between these appointments. Processor 102 also performs method 200 and determines for multiple activities the available time. The travel time is then the time it would take user 116 to travel from the event location to the activity location and back to the same event location.

In yet another example, the user 116 may arrive at a location at a certain time and that is before an event takes place at that location. For example, the user arrives at an airport by plane two hours before a meeting in the city. In this example, the arrival at the airport is also an ‘event’ with an event location, which shows that events do not necessarily need to have a duration. In these cases, the start and end times discussed above are simply the event times, such as arrival time or departure time.

In other examples, the calendar display shows the travel to the second event location similar to an event entry with a duration but with a different appearance, such as colour or alignment. That is, the time the user 116 needs to travel to the second event location is marked ‘busy’ because no other activities can be booked during that time. This indication of travel time may also be regarded as the first event and the associated event location is the arrival location and the time between the arrival and the beginning of the second event is regarded as the free time. Of course, the free time may be the time between the arrival at a location and the departure from that location, such as activities around a transit airport during the transit time. In this example, if the user 116 is interested in visiting the city of the transit airport, the user 116 can easily see how long the user 116 can spend in the city between travelling from the airport to the city and travelling back and can decide whether it is worth the effort.

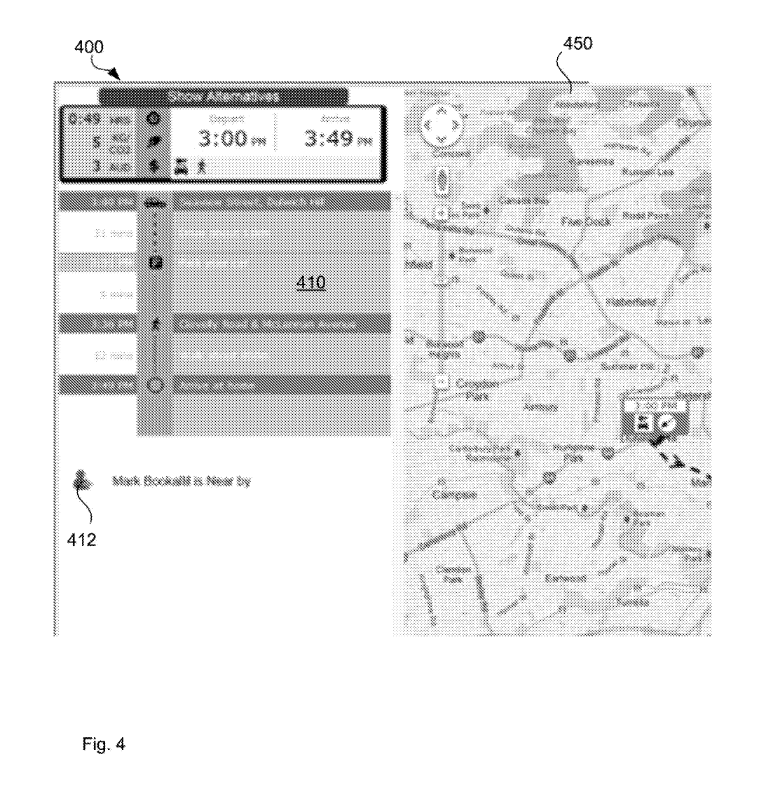

FIG. 4 illustrates a detailed view 400 of a transport route 410 and map view 450. A selectable marker in form of a people flag 412 is present representing a friend is available for a meetup in the time available on the trip.

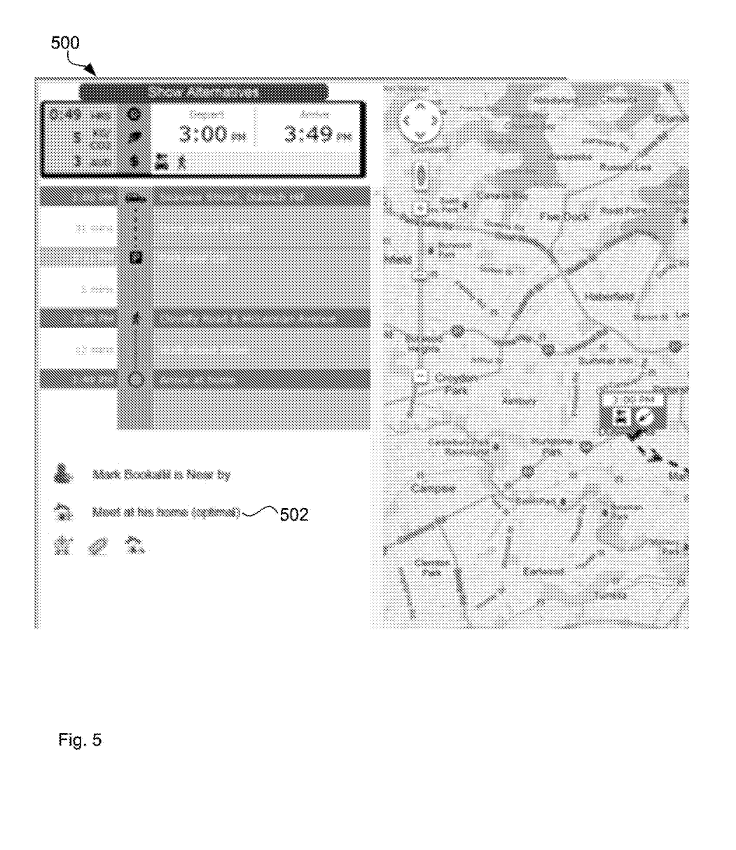

FIG. 5 illustrates a display 500 after the friend flag 412 in FIG. 4 has been selected. More graphical elements come up to select where the meeting can take place. The “optimal” meeting place 502 is listed first representing the location of least effort for both people.

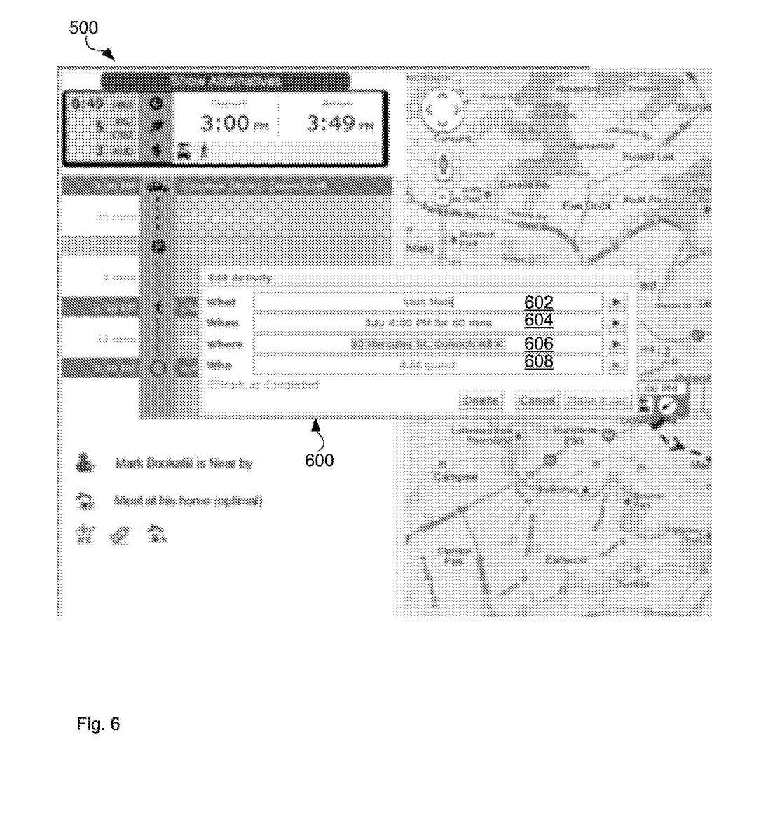

FIG. 6 illustrates the display 500 from FIG. 5 with a 4W form 600, that is, an element in the user interface that allows the user 116 to enter data for the what 602, when 604, where 606 and who 608 of the activity, that is, what the activity is, when the activity is performed, where the activity is performed (activity location) and who will also join the activity.

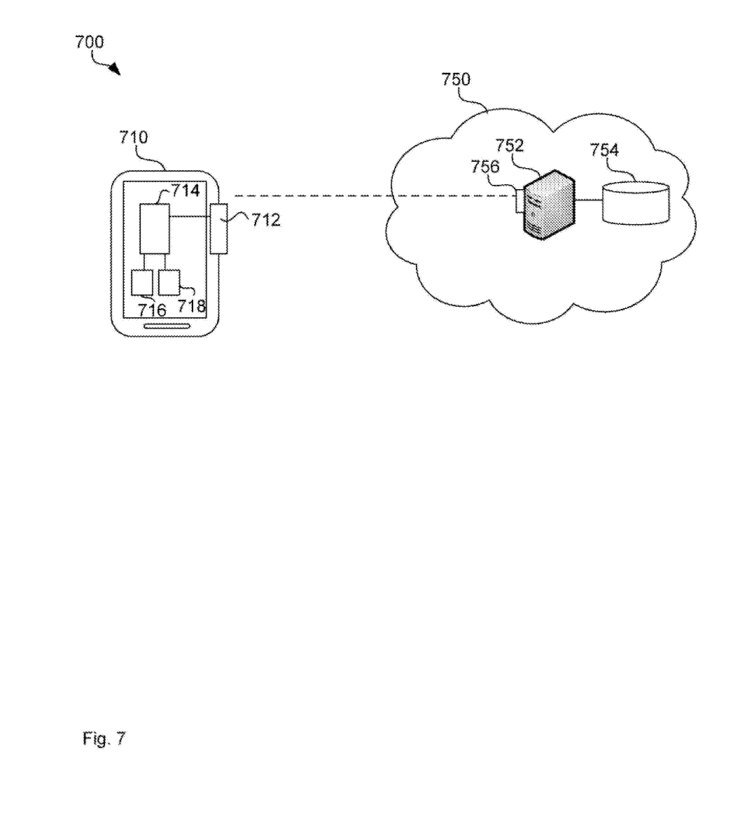

FIG. 7 illustrates a computer network 700 comprising a smart phone 710 and a distributed cloud computing environment 750 including a virtual machine 752. The smart phone 710 may also be a personal computer, laptop or any other mobile or stationary computing device. The cloud 750 may also be a single server or any other service providing computing power.

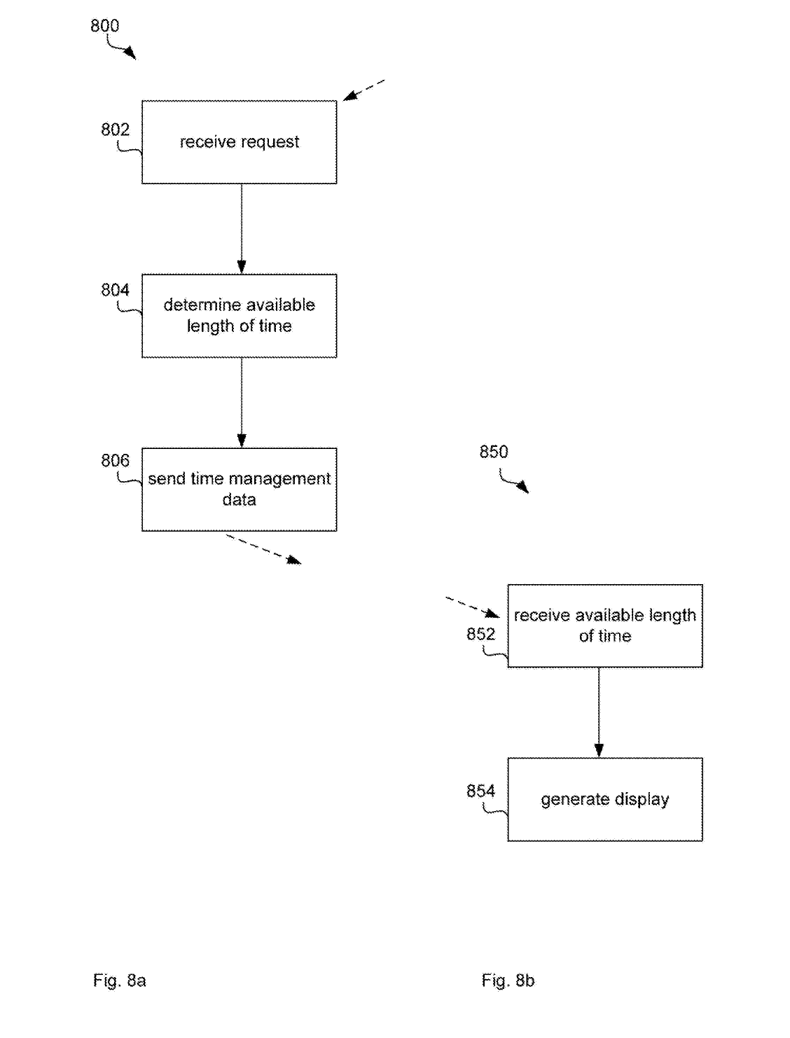

The smart phone 710 has a data port 712, such as GSM, LTE or Wifi module, a processor 714, a program memory 716 and a data memory 718 similar to the computer system 100 in FIG. 1. The smart phone 710 has software, such as an iPhone/iPad or Android app, installed on program memory 716, which causes processor 714 to perform the method 850 in FIG. 8b.

Similarly, the virtual machine 752 in cloud 750 has a processor, program memory and data memory (not shown). Software installed on the program memory of virtual machine 752 causes the processor of virtual machine 752 perform the method 800 in FIG. 8a. The cloud 750 further hosts a data store 754 to store activities with respective activity locations and for a particular user multiple events with respective event locations. The virtual machine 752 has a data port 756, such as a virtual LAN connection, to send data to the smart phone 710. Of course, the data store 754 may comprise many different physical data hosts and the virtual machine 752 may be replaced by a large number of virtual machines that are instantiated dynamically on-demand.

FIG. 8a illustrates a method for managing a time period as performed by virtual machine 752 while FIG. 8b illustrates a method for managing a time period as performed by smart phone 710.

The smart phone 710 sends a request, such as a JSON RPC request, for time management data to the virtual machine 752. The virtual machine 752 receives 802 the request, which triggers the virtual machine 752 to determine 804 an available length of time for multiple activities as explained earlier. The virtual machine 752 sends the available length of time for each activity to the smart phone 710, such as in a JSON format.

The smart phone 710 performs method 850, that is, receives the available length of time for each of the activities and renders the display described with reference to FIG. 3. In one example the display is a website rendered by a browser application and the smart phone 710 downloads the graphics, such as CSS, rules, graphics for markers etc. the first time the method 850 is performed and then uses the same graphics from a cache. In another example, the display is rendered by a custom made software application (app) and the graphics are installed on the smart phone 710 together with the software when the software is installed on the smart phone 710.

It will be appreciated by persons skilled in the art that numerous variations and/or modifications may be made to the specific embodiments without departing from the scope as defined in the claims.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as the internet.

It should also be understood that, unless specifically stated otherwise as apparent from the following discussion, it is appreciated that throughout the description, discussions utilizing terms such as “estimating” or “processing” or “computing” or “calculating”, “optimizing” or “determining” or “displaying” or “maximising” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

The present embodiments are, therefore, to be considered in all respects as illustrative and not restrictive.

1. A computer implemented method for managing a time period in a calendar application between multiple events associated with respective event locations, the method comprising:
receiving from a requesting device a request for time management data;
determining for each of the multiple activities having respective activity locations an available length of time for performing that activity within the time period based on a travel time for travelling between the event locations and the activity location of that activity; and
sending the time management data including the available length of time for each of the multiple activities to the requesting device.

2. The method of claim 1, further comprising determining for each activity a routing for travelling between the event locations and the activity location of that activity wherein determining the travel time is based on the routing.

3. The method of claim 2, wherein the routing is based one or more transport modes that are available for travelling between the event locations and the activity location during the time period.

4. The method of claim 1, further comprising determining a distance to each of the activity locations and sending the distance to the requesting device.

5. The method of claim 4, wherein determining the distance is based on one or more of:
a distance from one of the multiple events to the activity location;
a distance from a route between the multiple events to the activity location;
a distance difference between travelling between the multiple event locations directly and travelling between the multiple event locations via the activity location.

6. The method of claim, 1 wherein one of the multiple activities is a meeting with a contact and determining the available length of time for the one activity is based on an availability of the contact at the activity location of the one activity.

7. The method of claim 1, wherein one of the multiple activities is a meeting of a user of the calendar application with a contact and the method further comprises determining the activity location of the one activity such that a cost for the user and the contact is minimised.

8. A non-transitory computer readable medium, including computer-executable instructions stored thereon that when executed by a processor causes the processor to perform the method of claim 1.

9. A computer system for managing a time period in a calendar application between multiple events associated with respective event locations, the computer system comprising:
a data store to store for each of multiple activities an activity location and to store for each of the multiple events the associated event location;
a processor to determine for each of the multiple activities an available length of time for performing that activity within the time period based on a travel time for travelling between the event locations and the activity location of that activity; and
a data port to send the time management data including the available length of time for each of the multiple activities to the requesting device.

10. A computer implemented method for managing a time period in a calendar application between multiple events associated with respective event locations, the method comprising:
receiving for each of the multiple activities associated with respective activity locations an available length of time for performing that activity within the time period based on a travel time for travelling between the event locations and the activity location of that activity; and
generating a display for use in the calendar application, the display comprising for each of the one or more activities an indication of the available length of time for performing that activity and displaying an option for the user to select one of the multiple activities.

11. The method of claim 10, wherein the display further comprises a selectable marker for each of the one or more activities as the option for the user to select one of the multiple activities.

12. The method of claim 11, wherein the placement of the marker along an axis of the display is indicative of the available length of time.

13. The method of claim 11, wherein the placement of the marker along an axis of the display may be indicative of the travel time to the activity location.

14. The method of claim 11 wherein the placement of the marker along an axis of the display is indicative of a distance to the activity location.

15. The method of claim 1, wherein the display comprises a map with a selectable marker for each of the multiple activities and the placement of the marker on the map is indicative of the activity location.

16. The method of claim 15, wherein the map comprises an indication of a boundary that indicates locations that when taken as activity location result in an available length of time above a time threshold.

17. The method of any one of the claim 11, wherein a visual appearance of each marker is indicative of an activity type.

18. A non-transitory computer readable medium, including computer-executable instructions stored thereon that when executed by a processor causes the processor to perform the method of claim 10.

19. A computer system for managing a time period in a calendar application between multiple events associated with respective event locations, the computer system comprising:
a data port to receive for each of the multiple activities associated with respective activity locations an available length of time for performing that activity within the time period based on a travel time for travelling between the event locations and the activity location of that activity; and
a processor to generate a display for use in the calendar application, the display comprising for each of the one or more activities an indication of the available length of time for performing that activity and displaying an option for the user to select one of the multiple activities.

20. The computer system of claim 19 further comprising a display device to show the display generated by the processor to a user.
